(19) United States
(12) Patent Application Publication
(10) Pub. No.: US 2024/0425116 A1
(43) Pub. Date: Dec. 26, 2024

(54) REINFORCEMENT ELEMENT FOR REINFORCING A STRUCTURAL ELEMENT

(71) Applicant: SIKA TECHNOLOGY AG, Baar (CH)

(72) Inventors: Istvan TATRAI, Chereng (FR); Yannick HAEGEL, Villeneuve d'ascq (FR); David ANNENKOFF, Wasquehal (FR); Michael MEIER, Niederrohrdorf (CH)

(73) Assignee: SIKA TECHNOLOGY AG, Baar (CH)

(21) Appl. No.: 18/694,305

(22) PCT Filed: Sep. 21, 2022
(86) PCT No.: PCT/EP2022/076168

§ 371 Date: Mar. 21, 2024

(30) Foreign Application Priority Data
Sep. 24, 2021 (EP) 21198990.0

(51) Int. Cl. B62D 21/15; B32B 5/20; B62D 25/06; B62D 29/00

(52) U.S. Cl. CPC B62D 21/15; B32B 5/20; B62D 25/06; B62D 29/002; B32B 2605/00

(57) ABSTRACT

A system of a reinforced structural element of a motor vehicle includes a reinforcing element and a structural element, wherein the reinforcing element is arranged in a cavity of the structural element. The structural element is a front roof cross member of a body of the motor vehicle.

The invention relates to a reinforcement element for reinforcing a structural element in a motor vehicle.

In many cases, components such as, for example, vehicle bodies and/or frames of means of transport and locomotion, especially of water or land vehicles or of aircraft, have structures with cavities in order to enable lightweight constructions. However, these cavities cause a wide variety of problems. Depending on the type of the cavity, the latter has to be sealed in order to prevent the ingress of moisture and soiling, which can lead to corrosion of the components. It is often also desirable to substantially reinforce the cavities and hence the element, but to maintain the low weight. It is often also necessary to stabilize the cavities and hence the components, in order to reduce noise which would otherwise be transmitted along or through the cavity. Many of these cavities have an irregular shape or a narrow extent, which makes it more difficult to seal, reinforce and insulate them properly.

Especially in automotive construction, but also in aircraft construction and boatbuilding, sealing elements (baffles) are therefore used in order to seal and/or acoustically insulate cavities, or reinforcement elements (reinforcers) are used in order to reinforce cavities.

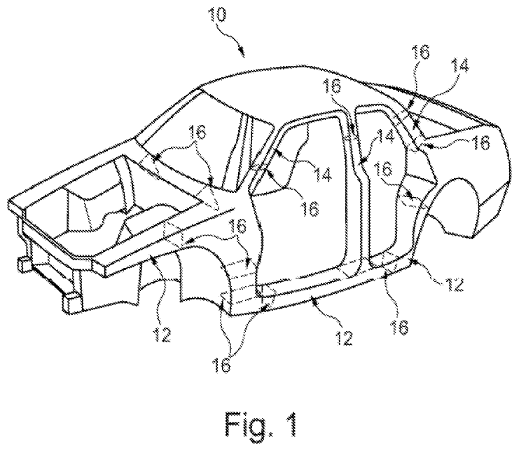

FIG. 1 shows schematically a vehicle body of an automobile. The vehicle body 10 here has various structures with cavities, for example pillars 14 and beams or crossbeams 12. Such structural elements 12, 14 with cavities are usually sealed and/or reinforced using sealing and/or reinforcement elements 16.

The disadvantage with such reinforcement elements and similar known reinforcement elements is that, as a result, particularly a roof region on vehicles with large panoramic roofs is inadequately reinforced. Particularly in the case of very large and wide vehicles, it has been observed that the roof region may be inadequately reinforced by known reinforcement elements.

It is therefore the underlying object of the invention to make available an improved reinforcement element and an improved reinforced structural element which, in particular, allows better reinforcement of the roof structure, especially on large vehicles with panoramic roofs.

This object is achieved by a system of a reinforced structural element of a motor vehicle, the system comprising: a reinforcement element, which has a support and an expandable material arranged thereon; and a structural element, which comprises an upper plate and a lower plate, wherein there is a cavity between the plates; wherein the reinforcement element is arranged in the cavity of the structural element, and wherein the structural element is a front roof crossmember of a vehicle body of the motor vehicle.

The solution proposed here has the advantage that the provision of a reinforcement element in the front roof crossmember of the vehicle body makes it possible to achieve significantly improved reinforcement of the roof structure. This is important especially on vehicles which have panoramic roofs, where further crossbracing of the roof can be achieved only with difficulty.

It has been found that the conventionally used reinforcement elements in side members of the roof structure may not adequately reinforce the roof region in certain situations. The use according to the invention of a reinforcement element in the front roof crossmember of the vehicle body now makes it possible to maintain the integrity of the roof structure, even in the event of high effective forces.

The solution proposed here furthermore has the advantage that there is no need for any further adaptations to the vehicle body in the roof region. Only an already existing structure, namely the front roof crossmember, is reinforced. Thus, there is no need for any further adaptations of the design or of adjacent structures.

In the context of this invention, the terms “top side” and “bottom side” each refer to an entire peripheral surface of an overall shape of the reinforcement element.

Since the roof crossmember of the vehicle body has a clear orientation as regards the top and bottom in a state of use of the motor vehicle, the reinforcement element arranged therein, which likewise has a flat shape owing to the shape of the roof crossmember, likewise has a clear orientation of a top and bottom side.

In the context of this invention, the “front roof crossmember” is understood to mean the vehicle body structure which connects the A pillars of the vehicle body over the windshield.

In one exemplary embodiment, a length of the reinforcement element is from 60% to 90% of a length of the roof crossmember. In a preferred refinement, the length of the reinforcement element is from 65% to 85% of a length of the roof crossmember.

In one exemplary refinement, the reinforcement element is arranged substantially centrally in the roof crossmember, such that there is a free region in the cavity on both sides of the reinforcement element.

The provision of a reinforcement element which does not fill the roof crossmember as far as the edge offers the advantage that, as a result, a certain deformation is allowed in the end regions of the roof crossmember when acted upon by a force from the outside. By virtue of such a deformation of the end regions, a force which acts on the reinforcement element is reduced to such an extent that breakage of the reinforcement element can be avoided. Overall, therefore, better integrity of the overall structure is made possible than would be the case with longer reinforcement elements because, in that case, the reinforcement element would break above a certain load.

In one exemplary embodiment, the reinforcement element has at least one fixing element for positioning the reinforcement element in the structural element.

In one exemplary refinement, this at least one fixing element is designed as a pin. In an alternative refinement, the fixing element is designed as a clip.

In one exemplary embodiment, the fixing element is designed as a pin, and the reinforcement element has just one such pin.

In one exemplary embodiment, the pin is arranged on a bottom side of the reinforcement element.

In one exemplary embodiment, the bottom plate has an opening or recess in which the pin of the reinforcement element engages.

In one exemplary embodiment, the pin is arranged in a central region of the reinforcement element.

Arranging the pin in a central region of the reinforcement element has the advantage that, as a result, after the insertion of the pin into the opening or recess, the reinforcement element can be fitted into the cavity since rotation around the pin is made possible. It is thereby possible to ensure that the reinforcement element is rotated into the correct position when the upper and lower plates are joined together. For this purpose, the reinforcement element can, for example, have corner regions with spacers which ensure correct positioning between the plates.

If the pin were arranged in an end region of the reinforcement element, then such a rotary turning adaptation to the cavity would only be partially possible because the end region which was closer to the pin would be able to rotate less than the end region which was further away.

In one exemplary embodiment, the pin has a hole in a region of the pin bottom.

The provision of such a hole in the bottom of the pin has the advantage that, as a result, the dip painting liquid can flow back out of the pin and does not accumulate therein in an unwanted way.

In one advantageous embodiment, the pin projects beyond the bottom side of the reinforcement element by 5 to 25 mm, preferably by 10 to 20 mm.

In one exemplary embodiment, the pin is of substantially frustoconical or cylindrical design.

In one exemplary embodiment, the pin is arranged in a region between two longitudinal ribs.

In one exemplary embodiment, the support has a plurality of longitudinal ribs and a plurality of transverse ribs.

In one exemplary refinement, the support has at least four longitudinal ribs and/or the support has at least twelve transverse ribs.

In one exemplary embodiment, the longitudinal ribs of the support are thicker than the transverse ribs of the support.

In one exemplary refinement, the longitudinal ribs are thicker than 3 mm, and the transverse ribs are thinner than 3 mm.

By means of such dimensioning of the longitudinal and transverse ribs, it is possible to ensure that, during an injection molding process for the support, better distribution of the support material in the longitudinal direction can be guaranteed by greater material thickness, thereby making it possible to produce the support with a reduced number of injection points.

In one exemplary embodiment, less expandable material is arranged on a top side of the reinforcement element than on a bottom side of the reinforcement element.

This has the advantage that, in the event of a load, compression of the lower plate can be prevented and, in addition, that the frequently occurring cutouts in the lower plate that are often necessary for various connections from the underside can be compensated.

In one exemplary refinement, less than 50% of the top side is covered with expandable material, and more than 50% of the bottom side is covered with expandable material.

In one exemplary refinement, less than 45%, in particular less than 40%, of the top side is covered with expandable material, and more than 55%, in particular more than 60%, of the bottom side is covered with expandable material.

In one exemplary embodiment, the expandable material on the top side is arranged in two strips, which are bounded by longitudinal ribs, and/or the expandable material on the bottom side is arranged in three strips, which are bounded by longitudinal ribs.

In an alternative exemplary embodiment, the expandable material on the top side is arranged in a single strip, which is bounded by longitudinal ribs, and/or the expandable material on the bottom side is arranged in two strips, which are bounded by longitudinal ribs.

Such an arrangement of the expandable material on the support makes it possible to use a support structure which has a notched cross section. Using corresponding transverse ribs, it is thereby possible to produce particularly load-stable support structures.

In one exemplary embodiment, the longitudinal ribs are of arc-shaped design/curved.

In particular, the longitudinal ribs are formed in a curved shape which is predetermined by the front roof crossmember.

In one exemplary embodiment, the longitudinal ribs run substantially parallel to one another.

In one exemplary embodiment, the transverse ribs are each formed perpendicularly to the curved shape of the longitudinal ribs and, as a result, are not parallel to one another.

In an alternative embodiment, the transverse ribs are formed parallel to one another but are not perpendicular to the curve shape of the longitudinal ribs in all cases.

In one exemplary embodiment, a length of the reinforcement element is between 600 mm and 1100 mm, in particular between 700 and 900 mm.

In one exemplary embodiment, a width of the reinforcement element is between 70 mm and 300 mm, in particular between 120 mm and 250 mm.

In one exemplary embodiment, a thickness of the expandable material, in each case measured perpendicularly to the top side and to the bottom side of the reinforcement element, is between 1.5 and 5 mm, in particular between 2 and 3 mm.

In one exemplary embodiment, the reinforcement element does not have any clips or welding tabs but is aligned in the cavity solely by a pin and spacer in corner regions of the reinforcement element.

In principle, various types of material that can be made to foam thermally can be used as the expandable material. This material can preferably have reinforcing properties.

Such an expandable material typically has a chemical or a physical blowing agent. Chemical blowing agents are organic or inorganic compounds which decompose under the influence of temperature, moisture or electromagnetic radiation, wherein at least one of the decomposition products is a gas. Physical blowing agents used may, for example, be compounds that are converted to the gaseous state of matter with increasing temperature. As a result, both chemical and physical blowing agents are capable of creating foam structures in polymers.

The expandable material is preferably foamed thermally, using chemical blowing agents. Examples of suitable chemical blowing agents are azodicarbonamides, sulfohydrazides, hydrogencarbonates or carbonates.

Suitable blowing agents are, for example, also commercially available under the trade name Expancel® from Akzo Nobel, the Netherlands, or under the trade name Celogen® from Chemtura Corp., USA.

The heat required for the foaming can be introduced by external or by internal heat sources, such as an exothermic chemical reaction. The foamable material can preferably be foamed at a temperature of ≤200° C., in particular from 120° C. to 190° C., preferably from 160° C. to 180° C.

Suitable expandable materials are, for example, one-component epoxy resin systems which do not flow at room temperature and in particular have elevated impact resistance and contain thixotropic agents such as aerosils or nanoclays. For example, epoxy resin systems of this type include 20% to 50% by weight of a liquid epoxy resin, 0% to 30% by weight of a solid epoxy resin, 5% to 30% by weight of impact modifiers, 1% to 5% by weight of physical or chemical blowing agents, 10% to 40% by weight of fillers, 1% to 10% by weight of thixotropic agents and 2% to 10% by weight of heat-activatable curing agents. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing blowing agents and based on crystalline polyesters which have OH groups and have been mixed with further polyols, preferably polyether polyols, and polyisocyanates with blocked isocyanate groups. The melting point of the crystalline polyester should be ≥50° C. The isocyanate groups of the polyisocyanate may be blocked, for example, by nucleophiles such as caprolactam, phenols or benzoxalones. Also suitable are blocked polyisocyanates as used, for example, in powder-coating technology, and commercially available, for example, under the Vestagon® BF 1350 and Vestagon® BF 1540 trade names from Degussa GmbH, Germany. Likewise suitable as isocyanates are so-called encapsulated or surface-deactivated polyisocyanates which are known to a person skilled in the art and are described, for example, in EP 0 204 970.

One exemplary expandable material with reinforcing properties is marketed under the trade name SikaReinforcer® 941 by Sika Corp., USA. This is furthermore described in U.S. Pat. No. 6,387,470.

Details and advantages of the invention will be described below hereunder by means of exemplary embodiments and with reference to schematic drawings. In the drawings:

FIG. 1 shows an exemplary illustration of a vehicle body;

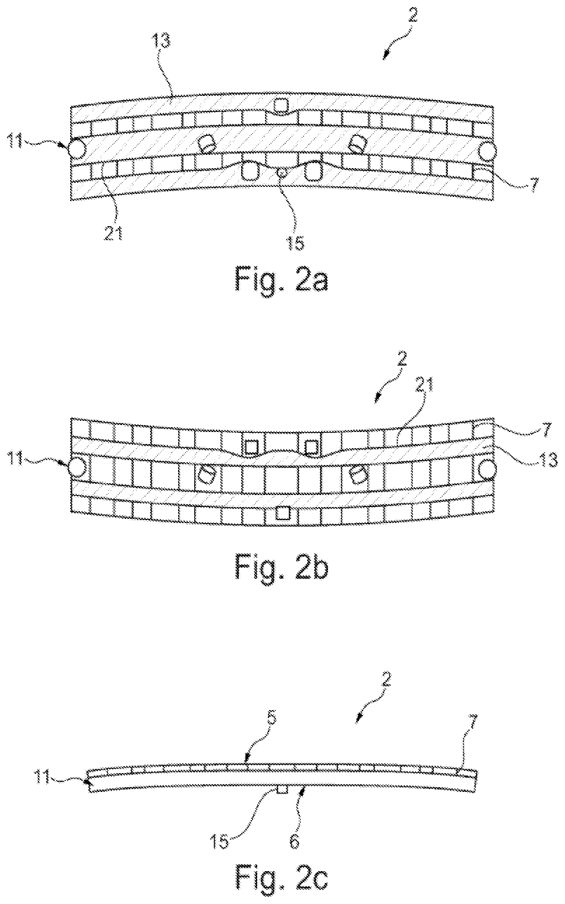

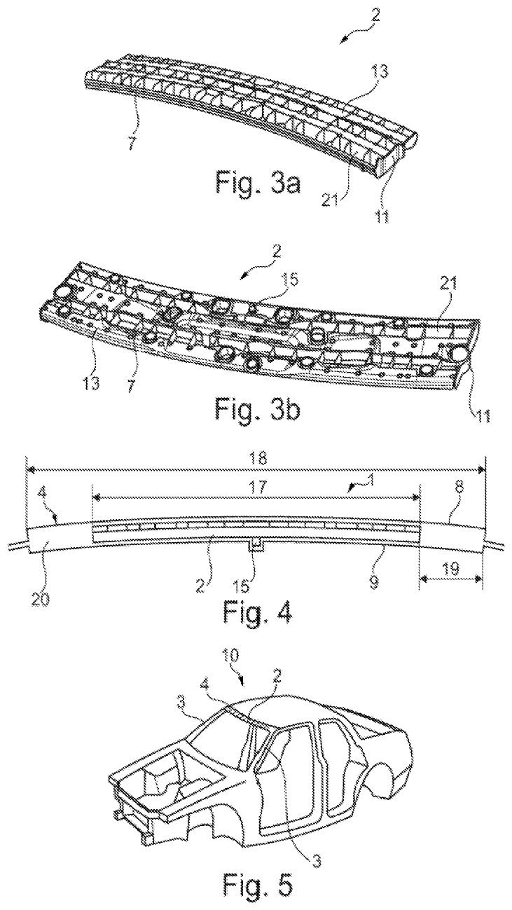

FIGS. 2a to 3b show an exemplary illustration of a reinforcement element;

FIG. 4 shows an exemplary illustration of a system of a reinforced structural element; and

FIG. 5 shows an exemplary illustration of a vehicle body with a reinforced structural element.

FIGS. 2a to 3b illustrate a reinforcement element 2 schematically and by way of example. In this case, FIG. 2a shows a bottom side 6 of the reinforcement element 2, FIG. 2b shows a top side 5 of the reinforcement element 2, FIG. 2c shows a side view of the reinforcement element 2, FIG. 3a shows a three-dimensional illustration obliquely from above of the reinforcement element 2, and, finally, FIG. 3b shows a three-dimensional illustration of the reinforcement element 2 with a view obliquely from below of the reinforcement element 2.

The reinforcement element 2 in each case comprises a support 11 and expandable material 13 arranged thereon. The support 11 has a plurality of longitudinal ribs 21 and a plurality of transverse ribs 7. In this exemplary embodiment, the expandable material 13 is in each case arranged in elongate strips, which are each delimited by longitudinal ribs 21. In this case, two such elongate strips of expandable material are arranged on the top side 5, and three such elongate strips of the expandable material 13 are arranged on the bottom side 6.

The reinforcement element 2 has a slightly curved shaped configuration, both in respect of the longitudinal direction and in respect of the extent in the vertical direction. It is thereby possible to ensure ideal fitting into the shape of the roof crossmember.

In this exemplary embodiment, the reinforcement element 2 has a single pin 15 as a fixing element, which is arranged on the bottom side 6 of the reinforcement element and which is arranged substantially in a central region of the reinforcement element 2.

A system 1 of a reinforced structural element is illustrated in FIG. 4. The structural element is a front roof crossmember 4, which comprises an upper plate 8 and a lower plate 9. The plates 8 and 9 are joined together in their end regions and form a cavity 20. The reinforcement element 2 is arranged in this cavity 20. In this exemplary embodiment, the positioning of the reinforcement element 2 in the roof crossmember 4 is accomplished by means of a pin 15 on the reinforcement element 2, which can be introduced into a recess in the lower plate 9, ensuring that the reinforcement element is roughly prefixed in its envisaged position. As the plates 8, 9 are brought together, the reinforcement element 2 can then rotate around the pin 15, thus ensuring that, after the closure of the cavity 20, the reinforcement element 2 is automatically rotated into the correct position by the plates 8, 9.

The reinforcement element 2 has a length 17 which is smaller than a length 18 of the roof crossmember 4. As a result, there remain free regions 19 in the cavity 20 on both sides of the reinforcement element 2. Such free regions 19 serve to enable these end regions of the roof crossmember 4 to deform slightly under the loading of the structure and, as a result, a maximum load on the reinforcement element 2 is decisively reduced, ensuring that the reinforcement element 2 does not break.

Finally, FIG. 5 illustrates a vehicle body 10, in which a reinforcement element 2 for reinforcing the roof region is arranged in the front roof crossmember 4.

### LIST OF REFERENCE SIGNS

1 System
2 Reinforcement element
3 A pillar
4 Front roof crossmember
5 Top side
6 Bottom side
7 Transverse rib
8 Upper plate
9 Lower plate
10 Vehicle body
11 Carrier
12 Structural element
13 Expandable material
14 Structural element
15 Pin
16 Insulating element
17 Length of the reinforcement element
18 Length of the roof crossmember
19 Free region
20 Cavity
21 Longitudinal rib

1. A system of a reinforced structural element of a motor vehicle, the system comprising:
a reinforcement element, which has a support and an expandable material arranged thereon; and
a structural element, which comprises an upper plate and a lower plate, wherein there is a cavity between the plates;
wherein the reinforcement element is arranged in the cavity of the structural element, and
wherein the structural element is a front roof crossmember of a vehicle body of the motor vehicle.

2. The system as claimed in claim 1, wherein a length of the reinforcement element is from 60% to 90% of a length of the front roof crossmember.

3. The system as claimed in claim 1, wherein the reinforcement element is arranged substantially centrally in the front roof crossmember, such that there is a free region in the cavity on both sides of the reinforcement element.

4. The system as claimed in claim 1, wherein the reinforcement element has at least one fixing element for positioning the reinforcement element in the structural element.

5. The system as claimed in claim 4, wherein the fixing element is designed as a pin.

6. The system as claimed in claim 5, wherein the pin is arranged on a bottom side of the reinforcement element.

7. The system as claimed in claim 6, wherein the bottom plate has an opening or recess in which the pin of the reinforcement element engages.

8. The system as claimed in claim 5, wherein the reinforcement element has just one pin.

9. The system as claimed in claim 8, wherein the pin is arranged in a central region of the reinforcement element.

10. The system as claimed in claim 5, wherein the pin has a hole in a region of a pin bottom.

11. The system as claimed in claim 1, wherein the support has at least four longitudinal ribs and/or at least twelve transverse ribs.

12. The system as claimed in claim 1, wherein longitudinal ribs of the support are thicker than transverse ribs of the support.

13. The system as claimed in claim 1, wherein less expandable material is arranged on a top side of the reinforcement element than on a bottom side of the reinforcement element.

14. The system as claimed in claim 1, wherein the expandable material on the top side is arranged in two strips, which are bounded by longitudinal ribs, and/or wherein the expandable material on the bottom side is arranged in three strips, which are bounded by longitudinal ribs.

15. The system as claimed in claim 1, wherein the longitudinal ribs are curved and/or wherein the longitudinal ribs run substantially parallel to one another.
